(19) United States
(12) Patent Application Publication
(10) Pub. No.: US 2018/0046470 A1
(43) Pub. Date: Feb. 15, 2018

(54) METHODS, SYSTEMS, AND MEDIA FOR PRESENTING A USER INTERFACE CUSTOMIZED FOR A PREDICTED USER ACTIVITY

(71) Applicant: Google Inc., Mountain View, CA (US)

(72) Inventors: Rodrigo de Oliveira, Saratoga, CA (US); Christopher Pentoney, Pacifica, CA (US)

(21) Appl. No.: 15/234,446

(22) Filed: Aug. 11, 2016

(51) Int. Cl. G06F 9/44; G06F 17/30; G06N 7/00; G06F 3/0482

(52) U.S. Cl. CPC G06F 9/4443; G06F 3/0482; G06F 17/30867; G06N 7/005

(57) ABSTRACT

Methods, systems, and media for presenting a user interface customized for a predicted user activity are provided. In some embodiments, the method comprises: selecting users of a content delivery service, causing user devices to prompt the associated users to provide subjective data related to the user's intent when requesting media content items, training a predictive model to identify a user's subjective intent in requesting a media content item based on objective data received from a user device associated with the user and the subjective data received from the user devices, wherein the predictive model is trained to identify whether to present the user with a first user interface associated with a first user intent or a second user interface associated with a second user intent, causing the first user interface or the second user interface to be presented. Entertainment

### TECHNICAL FIELD

The disclosed subject matter relates to methods, systems, and media for presenting a user interface customized for a predicted user activity.

### BACKGROUND

Many users choose to access media content from services that have large collections of different media content items. Often, users may access these different media content items in different contexts. For example, users may access an instructional video for entertainment in some situations and for information about how to perform a task in other situations. However, most services provide only a single user experience for consuming content, or require users to manually choose how the content is going to be presented.

Accordingly, it is desirable to provide new methods, systems, and media for presenting a user interface customized for a predicted user activity.

### SUMMARY

In accordance with some embodiments of the disclosed subject matter, mechanisms for presenting a user interface customized for a predicted user activity are provided.

In accordance with some embodiments of the disclosed subject matter, a method for presenting a custom user interface is provided, the method comprising: selecting at least a plurality of users of a content delivery service from users of the content delivery service; for a plurality of user devices associated with the plurality of users: receiving requests for media content items; receiving objective data related to the context in which the requests for media content items were made; causing each of the plurality of user devices to prompt the associated users to provide subjective data related to the user's intent when requesting the media content items; and receiving subjective data generated based on user input responsive to the prompt; receiving, from a first user device, input that maps each of a plurality of user intents to at least one of a plurality of different user interfaces for presenting media content items; training a predictive model to identify a user's subjective intent in requesting a media content item based on objective data received from a user device associated with the user using at least a portion of the objective data received from the plurality of user devices and at least a portion of the subjective data received from the plurality of user devices, wherein the predictive model is trained to identify whether to present the user with a first user interface associated with a first user intent or a second user interface associated with a second user intent; receiving, from a second user device, a request for a first media content item; receiving, from the second user device, objective data related to the context in which the request for the first media content item was made; providing at least a portion of the objective data received from the second user device to the predictive model; receiving a first output from the predictive model indicating that the second user device is to present the first media content item using the first user interface; in response to receiving the first output from the predictive model, causing the second user device to present the first media content item using the first user interface; receiving, from a third user device, a request for the first media content item; receiving, from the third user device, objective data related to the context in which the request for the first media content item was made; providing at least a portion of the objective data received from the third user device to the predictive model; receiving a second output from the predictive model indicating that the third user device is to present the first media content item using the second user interface; and in response to receiving the second output from the predictive model, causing the third user device to present the first media content item using the second user interface.

In some embodiments, a first user intent of the plurality of user intents is an intent to consume the media content item for information included in the media content item.

In some embodiments, a second user intent of the plurality of user intents is an intent to consume the media content item for entertainment.

In some embodiments, causing each of the plurality of user devices to prompt the associated users comprises causing each of the plurality of user devices to query the user to determine whether the user intended to consume the requested media content primarily for entertainment or primarily for the information included in the media content.

In some embodiments, the objective data includes information indicating whether the request was initiated from search results provided through the content delivery service.

In some embodiments, the objective data includes a search query that was used in initiating the search.

In accordance with some embodiments of the disclosed subject matter, a method for presenting a customized user interface is provided, the method comprising: identifying contextual information related to the context in which the requests for media content items were made from a plurality of user devices associated with the plurality of users; providing a prompt to each of the plurality of user devices to provide intent information related to the user's intent when requesting the media content items; receiving the intent information in response to the prompt; generating a trained predictive model that identifies a user's intent when requesting a media content item with the identified contextual information and the received intent information, wherein the trained predictive model determines which version of a user interface is to be presented based on a predicted user intent determined based on information related to the context in which a request for media content is being made; receiving, from a second plurality of user devices, requests for media content items; identifying, for each request for a media content item received from the second plurality of user devices, contextual information related to the context in which the request for the media content items was made; receiving, for each request for a media content item received from the second plurality of user devices, an output from the predictive model indicating which version of the user interface to present based on at least a portion of the identified context information; and causing each of the second plurality of user devices to present a version of the user interface for presenting media content based on the output from the predictive model, wherein two user devices of the second plurality of user devices are caused to present two different versions of the user interface to present the same media content item based on the output of the predictive model.

In accordance with some embodiments of the disclosed subject matter, a system for presenting a custom user interface is provided, the system comprising: a memory that stores computer-executable instructions; and a hardware processor that, when executing the computer-executable instructions stored in the memory, is configured to: select at least a plurality of users of a content delivery service from users of the content delivery service; for a plurality of user devices associated with the plurality of users: receive requests for media content items; receive objective data related to the context in which the requests for media content items were made; cause each of the plurality of user devices to prompt the associated users to provide subjective data related to the user's intent when requesting the media content items; and receive subjective data generated based on user input responsive to the prompt; receive, from a first user device, input that maps each of a plurality of user intents to at least one of a plurality of different user interfaces for presenting media content items; train a predictive model to identify a user's subjective intent in requesting a media content item based on objective data received from a user device associated with the user using at least a portion of the objective data received from the plurality of user devices and at least a portion of the subjective data received from the plurality of user devices, wherein the predictive model is trained to identify whether to present the user with a first user interface associated with a first user intent or a second user interface associated with a second user intent; receive, from a second user device, a request for a first media content item; receiving, from the second user device, objective data related to the context in which the request for the first media content item was made; provide at least a portion of the objective data received from the second user device to the predictive model; receive a first output from the predictive model indicating that the second user device is to present the first media content item using the first user interface; in response to receiving the first output from the predictive model, cause the second user device to present the first media content item using the first user interface; receive, from a third user device, a request for the first media content item; receive, from the third user device, objective data related to the context in which the request for the first media content item was made; provide at least a portion of the objective data received from the third user device to the predictive model; receive a second output from the predictive model indicating that the third user device is to present the first media content item using the second user interface; and in response to receiving the second output from the predictive model, cause the third user device to present the first media content item using the second user interface.

In accordance with some embodiments of the disclosed subject matter, a non-transitory computer-readable medium containing computer-executable instructions that, when executed by a processor, cause the processor to perform a method for presenting a custom user interface is provided. The method comprising: selecting at least a plurality of users of a content delivery service from users of the content delivery service; for a plurality of user devices associated with the plurality of users: receiving requests for media content items; receiving objective data related to the context in which the requests for media content items were made; causing each of the plurality of user devices to prompt the associated users to provide subjective data related to the user's intent when requesting the media content items; and receiving subjective data generated based on user input responsive to the prompt; receiving, from a first user device, input that maps each of a plurality of user intents to at least one of a plurality of different user interfaces for presenting media content items; training a predictive model to identify a user's subjective intent in requesting a media content item based on objective data received from a user device associated with the user using at least a portion of the objective data received from the plurality of user devices and at least a portion of the subjective data received from the plurality of user devices, wherein the predictive model is trained to identify whether to present the user with a first user interface associated with a first user intent or a second user interface associated with a second user intent; receiving, from a second user device, a request for a first media content item; receiving, from the second user device, objective data related to the context in which the request for the first media content item was made; providing at least a portion of the objective data received from the second user device to the predictive model; receiving a first output from the predictive model indicating that the second user device is to present the first media content item using the first user interface; in response to receiving the first output from the predictive model, causing the second user device to present the first media content item using the first user interface; receiving, from a third user device, a request for the first media content item; receiving, from the third user device, objective data related to the context in which the request for the first media content item was made; providing at least a portion of the objective data received from the third user device to the predictive model; receiving a second output from the predictive model indicating that the third user device is to present the first media content item using the second user interface; and in response to receiving the second output from the predictive model, causing the third user device to present the first media content item using the second user interface.

In accordance with some embodiments of the disclosed subject matter, a system for presenting a custom user interface is provided, the system comprising: means for selecting at least a plurality of users of a content delivery service from users of the content delivery service; for a plurality of user devices associated with the plurality of users: means for receiving requests for media content items; means for receiving objective data related to the context in which the requests for media content items were made; means for causing each of the plurality of user devices to prompt the associated users to provide subjective data related to the user's intent when requesting the media content items; and means for receiving subjective data generated based on user input responsive to the prompt; means for receiving, from a first user device, input that maps each of a plurality of user intents to at least one of a plurality of different user interfaces for presenting media content items; means for training a predictive model to identify a user's subjective intent in requesting a media content item based on objective data received from a user device associated with the user using at least a portion of the objective data received from the plurality of user devices and at least a portion of the subjective data received from the plurality of user devices, wherein the predictive model is trained to identify whether to present the user with a first user interface associated with a first user intent or a second user interface associated with a second user intent; means for receiving, from a second user device, a request for a first media content item; means for receiving, from the second user device, objective data related to the context in which the request for the first media content item was made; means for providing at least a portion of the objective data received from the second user device to the predictive model; receiving a first output from the predictive model indicating that the second user device is to present the first media content item using the first user interface; in response to receiving the first output from the predictive model, means for causing the second user device to present the first media content item using the first user interface; means for receiving, from a third user device, a request for the first media content item; means for receiving, from the third user device, objective data related to the context in which the request for the first media content item was made; means for providing at least a portion of the objective data received from the third user device to the predictive model; means for receiving a second output from the predictive model indicating that the third user device is to present the first media content item using the second user interface; and in response to receiving the second output from the predictive model, means for causing the third user device to present the first media content item using the second user interface.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a process for presenting a user interface customized for a predicted user activity in accordance with some embodiments of the disclosed subject matter.

FIG. 2 shows an example of a process for receiving information related to a user's intended activity with respect to a video item in accordance with some embodiments of the disclosed subject matter.

FIG. 3 shows an example of a process for training a model to predict an intended user activity in accordance with some embodiments of the disclosed subject matter.

FIG. 4 shows an example of a process for causing a user interface customized based on a predicted user activity to be presented in accordance with some embodiments of the disclosed subject matter.

FIG. 5 shows an example of a process for causing a user interface for a predicted instructional activity to be presented in accordance with some embodiments of the disclosed subject matter.

FIG. 6A shows an example of a user interface customized for an instructional user activity in accordance with some embodiments of the disclosed subject matter.

FIG. 6B shows an example of a user interface that is customized for an entertainment activity in accordance with some embodiments of the disclosed subject matter.

FIG. 7 shows a schematic diagram of a system suitable for implementation of the mechanisms described herein for presenting a user interface customized for a predicted user activity in accordance with some embodiments of the disclosed subject matter.

FIG. 8 shows an example of hardware that can be used in a server and/or a user device of FIG. 7 in accordance with some embodiments of the disclosed subject matter.

FIG. 9 shows a more detailed example of a system suitable for implementation of the mechanisms described herein for presenting a user interface customized for a predicted user activity in accordance with some embodiments of the disclosed subject matter.

### DETAILED DESCRIPTION

In accordance with various embodiments of the disclosed subject matter, mechanisms (which can include methods, systems, and media) for presenting a user interface customized for a predicted user activity are provided.

In some embodiments, the mechanisms described herein can use survey data regarding the intended activities of surveyed persons when they access media content items on media platforms to produce a model that can be used to predict the intended activity of a person associated with a request for a media content item and cause that person to be presented with a user interface that corresponds to the predicted intended activity without querying the person about their intentions. For example, the mechanisms can survey a group of users of a media platform (and/or other persons) with questions regarding their intended activity when requesting media content items and obtain information indicating that certain users intended to view video items as, for example, entertainment while others intended to view video items, for example, to learn how to perform a task. Based on this information, and information about the context in which users might request media items for these activities, in some embodiments, the mechanisms can train a model to predict when users, for example, intend to view a video item for entertainment and/or when users intend to view a video item to learn how to perform a task. In some embodiments, the mechanisms can use the prediction to cause a user interface customized for the predicted intended activity to be presented to the user. For example, if the model predicts that a user intends to view a video in a group setting, the mechanisms can cause the user to be presented with a user interface that presents the video item in a full screen mode and does not present user comments, menu options, and/or other user interface features. As another example, if the model predicts that a user intends to view a video for shopping, the mechanisms can cause the user to be presented with a user interface that includes advertisements, the prices of products, product reviews, and/or user comments.

It should be noted that, as used herein, the term “media content item” can be applied to video content, audio content, text content, image content, any other suitable media content, or any suitable combination thereof.

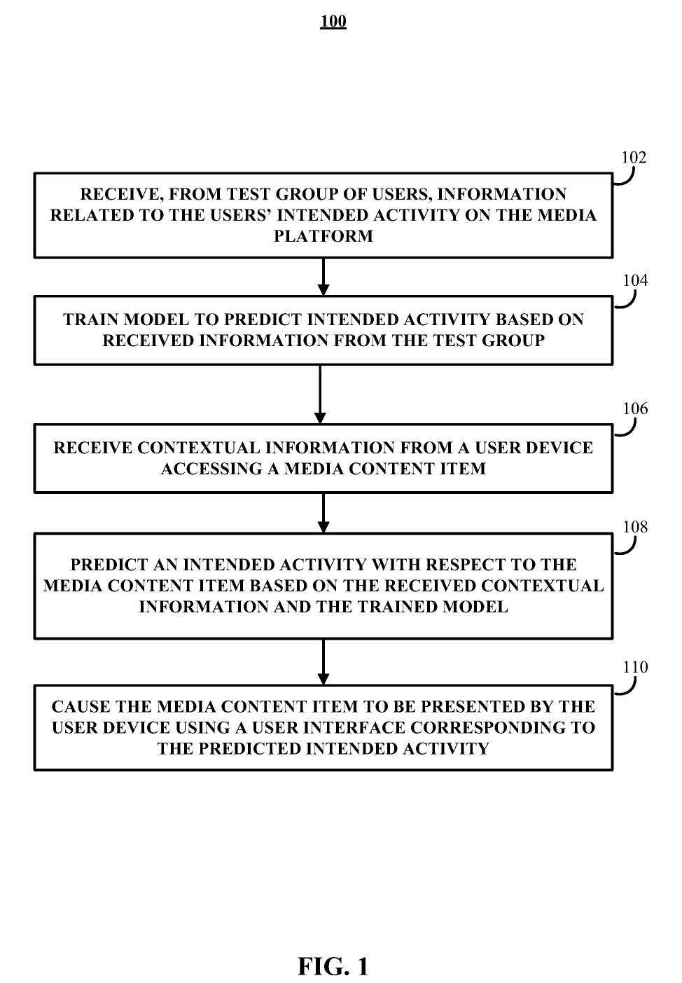

FIG. 1 shows an example of a process 100 for presenting a user interface customized for a predicted user activity in accordance with some embodiments of the disclosed subject matter.

At 102, process 100 can receive, from a test group of users, information related to their intended activity on the media platform.

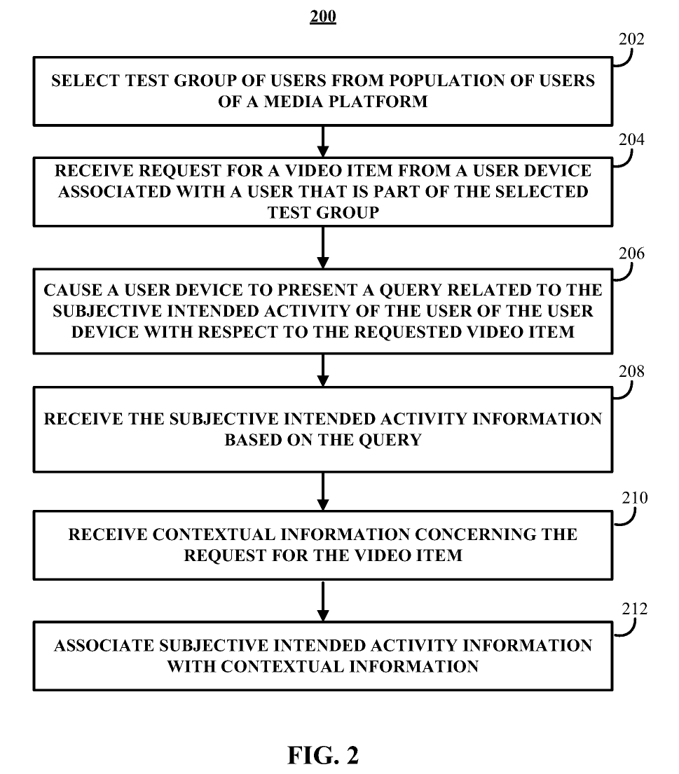

In some embodiments, process 100 can select the test group of users using any suitable technique or combination of techniques. For example, process 100 can select a test group as described below in connection with 202 of FIG. 2.

In some embodiments, process 100 can receive any suitable information related to the users' intended activity on the media platform. For example, process 100 can receive subjective information related to users' activity (e.g., information received in response to a query that asks the user to input a response concerning the user's intended activity when accessing the media platform, as described below in connection with 206 of FIG. 2). As another example, process 100 can receive contextual information from a user device being used to access the media platform (e.g., as described below in connection with 106), such as information concerning a request for a video item (e.g., as described above in connection with 210 of FIG. 2).

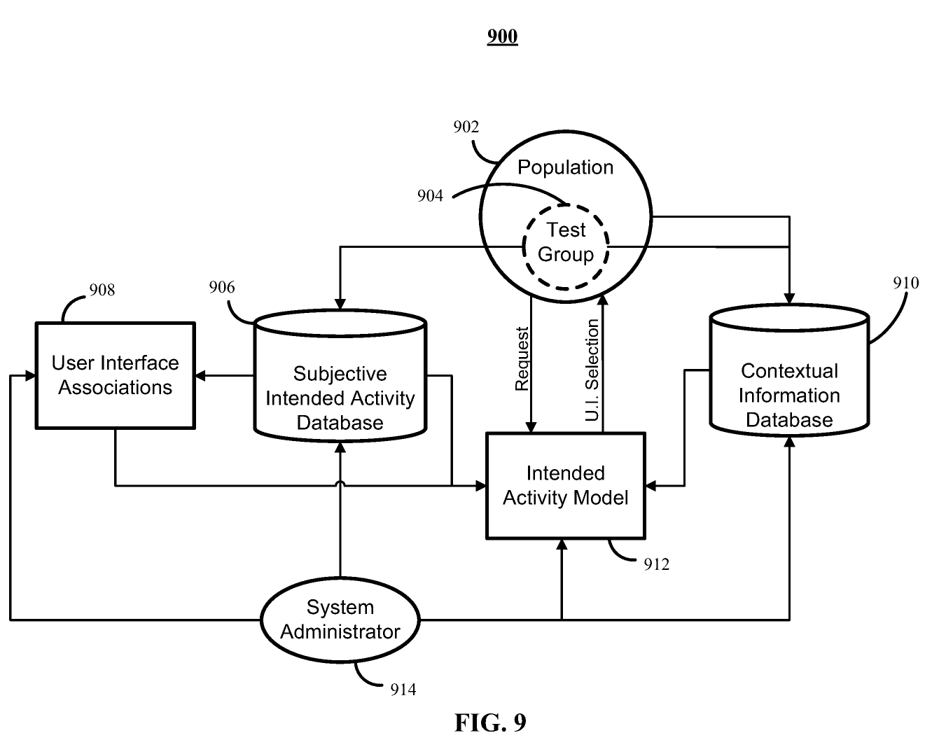

In some embodiments, process 100 can receive the information using any suitable technique or combination of techniques. For example, process 100 can receive subjective information by causing a user device that is being used to access the media platform (e.g., as described below in connection with 206 and/or 210 of FIG. 2) to query the user for the subjective information. As another example, process 100 can receive the information by querying a database that collects information related to user devices and/or user accounts that access the media platform (e.g., a subjective intended activity database and/or a contextual information database, as described below in connection with FIG. 9).

In some embodiments, in situations in which the mechanisms described herein collect personal information about users, or can make use of personal information, the users can be provided with an opportunity to control whether programs or features collect user information (e.g., behavioral data and/or contextual information, as described above), or to control whether and/or how such information can be used. In addition, certain data can be treated in one or more ways before it is stored or used, so that personal information is removed. For example, a user's identity can be treated so that no personal information can be determined for the user, or a user's geographic location can be generalized where location information is obtained (such as to a city, ZIP code, or state level), so that a particular location of a user cannot be determined. Thus, the user can have control over how information is collected about the user and used by the mechanisms described herein.

At 104, process 100 can train a model to predict intended activity for users of the media platform based on the information received from the test group.

In some embodiments, process 100 can train the model using any suitable technique or combination of techniques. For example, process 100 can use linear regression, logistic regression, other non-linear regression, step-wise regression, decision tree modeling, machine learning, pattern recognition, gradient boosting, analysis of variance, cluster analysis, any other suitable modeling technique, or any suitable combination thereof.

In some embodiments, process 100 can train the model to produce any suitable indicator of one or more predicted intended activities. For example, process 100 can train the model to output a score associated with one or more predicted intended activities, a probability associated with one or more predicted intended activities, a confidence level associated with one or more predicted intended activities, any other suitable indicator, or any suitable combination thereof. In some embodiments, process 100 can train the model to produce an indicator for each of two or more predicted intended activities.

In some embodiments process 100 can train the model using any suitable information. For example, process 100 can train the model based on information about requested media content items (e.g., media content items that were requested in connection with the received information from the test group). As a more particular example, process 100 can train the model based on metadata associated with the requested media content items, such as metadata that indicates, for example, a media category, a time length, a popularity, terms describing the media content item, any other suitable metadata associated with the requested media content item, or any suitable combination thereof.

At 106, process 100 can receive contextual information from a user device requesting a media content item.

In some embodiments, contextual information can be any suitable objective information. For example, the contextual information can be objective information related to the user device requesting the media content item, such as the type of device (e.g., mobile device, desktop computer, television device, or any other suitable type of device), a type of network that the device is connected to (e.g., a mobile network, a WiFi Network, a Local Area Network, or any other suitable type of network), a type of application being used on the user device to request the media content item (e.g., a web browser, a media presentation application, a media streaming application, a social media application, or any other suitable type of application), an operating system being used by the user device, any other suitable information related to the type of device, or any suitable combination thereof. As another example, the contextual information can be objective information related to the location of the user device requesting the media content item, such as a region associated with the user device (e.g., a time zone, a city, a state, any other suitable region, or any suitable combination thereof), a contextual location associated with the user (e.g., a home location, a work location, any other suitable contextual location, and/or any suitable combination thereof), or any other suitable information related to a location of the user device. As yet another example, the contextual information can be objective information related to the request for the media content item, such as a search query sent by the user device (e.g., a search query that led to the media content item), other media content items requested by the user device, one or more URLs recently requested by the user device, one or more URLs that are currently being accessed in a web browser of the user device, a URL and/or top-level domain of a web site that referred the user device to a URL associated with the media content item, the time at which the user device sent the request for the media content item, any other suitable information related to the request, or any suitable combination thereof. As still another example, the contextual information can be objective information related to the media content item being accessed, such as metadata information associated with the media content item, a popularity of the media content item, any other suitable information related to the media content item being accessed, or any suitable combination thereof.

In some embodiments, process 100 can receive the contextual information using any suitable technique or combination of techniques. For example, process 100 can request the contextual information from the user device. As another example, process 100 can request the contextual information from a database that stores the information (e.g., a contextual information database as described below in connection with FIG. 9). As a more particular example, in a situation in which the user device is logged into a known user account, process 100 can request contextual information from a database that stores user account preferences (e.g., user account information related to a language preference, a time zone preference, media presentation preferences, any other suitable contextual information associated with the user account, or any suitable combination thereof).

In some embodiments, in situations in which the mechanisms described herein collect personal information about users, or can make use of personal information, the users can be provided with an opportunity to control whether programs or features collect user information (e.g., behavioral data and/or contextual information, as described above), or to control whether and/or how such information can be used. In addition, certain data can be treated in one or more ways before it is stored or used, so that personal information is removed. For example, a user's identity can be treated so that no personal information can be determined for the user, or a user's geographic location can be generalized where location information is obtained (such as to a city, ZIP code, or state level), so that a particular location of a user cannot be determined. Thus, the user can have control over how information is collected about the user and used by the mechanisms described herein.

At 108, process 100 can predict an intended activity with respect to the requested media content item based on the received contextual information and the trained model.

In some embodiments, process 100 can input the received contextual information into the trained model to predict any suitable intended user activity with respect to the media content item. For example, the trained model can predict that the user intends to consume a media content item as part of a business presentation, as solo entertainment, while shopping, as educational instruction (e.g., when the media content item is a recording of a lecture), casual browsing, comedic entertainment, any other suitable activity, or any suitable combination thereof based on the received contextual information.

As another example, the trained model can predict that a user intends to consume a media content item as a group entertainment activity based on the received contextual information. As a more particular example, the trained model can predict that a user intends to watch a video item at home with one or more other people based on received contextual information indicating that, for example, a user device requested the video item on a Friday evening, via a WiFi connection, and the video item is to be presented using a television. Additionally or alternatively, depending on the subjective information received at 102, the trained model can predict any other suitable activity or any suitable combination of activities based on the same contextual information.

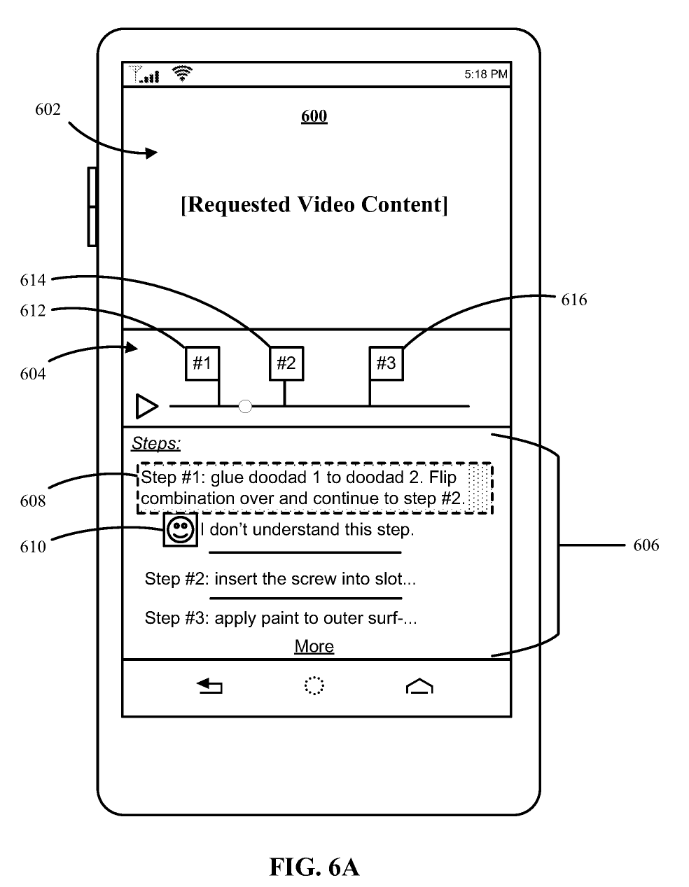

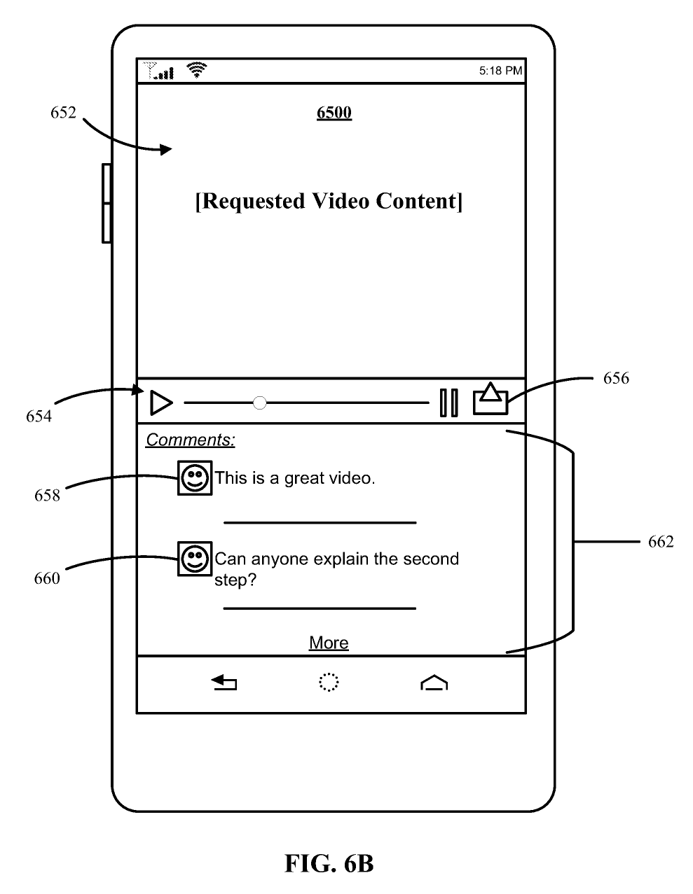

As yet another example, process 100 can predict that a user intends to consume a media content item as an instructional activity (e.g., as described below in connection with FIG. 6A). As a more particular example, the trained model can predict that a user intends to view a video item as an instructional activity based on received contextual information indicating that, for example, a user device requested the video item after sending a search query that included the terms “how to.” Additionally or alternatively, depending on the subjective information received at 102, the trained model can predict any other suitable activity or any suitable combination of activities based on the same contextual information. As another more particular example, in a situation where process 100 receives a request for the same video item, but receives contextual information indicating that the user device is a television device and that the search query included the term “funny,” in addition to or in lieu of “how to,” the trained model can predict that the user intends to view the video item as an entertainment activity. Additionally or alternatively, depending on the subjective information received at 102, the trained model can predict any other suitable activity or any suitable combination of activities based on the same contextual information.

In some embodiments, process 100 can predict an intended activity based on any suitable indicator produced by the intended activity model, such as any suitable indicator discussed above in connection with 104. For example, in a situation in which the predicted activity model produces a score and/or probability for two or more predicted activities, process 100 can predict the activity with the highest score and/or probability. As another example, process 100 can predict an intended activity by determining whether an indicator exceeds a predetermined threshold. In such an example, if no indicator of an intended activity exceeds the predetermined threshold, process 100 can abstain from predicting an intended activity.

At 110, process 100 can cause the media content item to be presented by the user device using a user interface corresponding to the predicted intended activity.

In some embodiments, process 100 can cause a user interface to be presented that includes features that are customized for the predicted activity. For example, in a situation where process 100 predicts that a user intends to watch a video item as an instructional activity (e.g., as described above in connection with 106 and below in connection with FIG. 6A), process 100 can cause a user interface to be presented that includes video markers (e.g., video markers 612, 614, and 616, as described below in connection with FIG. 6A) noting where particular steps of an instructional video are located and a listing of written instructions corresponding to the video item (e.g., instructions 606). As another example, in a situation where process 100 predicts that a user intends to present a slideshow as part of a business presentation, process 100 can cause a user interface to be presented that hides the selectable elements of the user interface. As yet another example, in a situation where process 100 predicts that a user intends to present a video item as part of a business presentation, process 100 can cause a user interface to be presented that includes selectable user interface elements that are larger than those included in a default user interface (e.g., a larger pause button, larger full screen button, any other selectable user interface element, or any suitable combination thereof).

In some embodiments, process 100 can cause a user interface to be presented using any suitable technique or combination of techniques. For example, process 100 can respond to the request by providing the requested media content item with instructions that cause an application of the user device to present a user interface that corresponds to the predicted activity. As a more particular example, in a situation where the application is a web browser, and the request was sent via the web browser, process 100 can respond to the request by providing HTML instructions that can cause the web browser to present a user interface that corresponds to the predicted activity. Additionally or alternatively, process 100 can respond to a request sent via a web browser by redirecting to a web page, where the requested media content item can be accessed, that includes a user interface that corresponds to the predicted activity.

In some embodiments, in addition to or in lieu of presenting a user interface that includes customized features, process 100 can cause a default user interface to be presented that includes user-selectable features that are pre-activated corresponding to the predicted activity. For example, process 100 can cause a default user interface to be presented that includes a mute feature that is pre-activated, a full screen feature that is pre-activated, a casting feature (e.g., a feature that causes a media content item to be presented by another device) that is pre-activated, any other suitable pre-activated feature, or any suitable combination thereof. As another example, process 100 can cause a default user interface to be presented that is modified to include more advertisements or fewer advertisements, more comments or fewer comments, a larger or smaller media presentation area, any other suitable modification, or any suitable combination thereof.

FIG. 2 shows an example 200 of a process for receiving information related to a user's intended activity for a video item in accordance with some embodiments of the disclosed subject matter.

At 202, process 200 can select a test group of users from a population of users of a media platform.

In some embodiments, process 200 can select a test group of users using any suitable information. For example, process 200 can select a test group based on information related to the users' geographic location, age, language preference, frequency of use, user device type, any other suitable information, or any suitable combination thereof. Additionally or alternatively, process 200 can select a test group of users randomly.

In some embodiments, process 200 can select a test group of users from a population of users of any suitable media platform. For example, process 200 can select users of a media platform that utilizes the mechanisms described herein for presenting a user interface customized for a predicted user activity, a third party media platform, any other suitable media platform, or any suitable combination thereof. Additionally or alternatively, process 200 can select a test group that includes persons that may not already use any media platform.

In some embodiments, process 200 can select a test group of users based on any suitable information that can be associated with a user. For example, process 200 can select a user account associated with a user, an e-mail address associated with a user, an IP address that can be associated with a user, any other suitable information that can be associated with a user, or any suitable combination thereof.

At 204, process 200 can receive a request for a video item from a user device associated with a user that is part of the selected test group using any suitable technique or combination of techniques. For example, process 200 can receive a request for a video item from a user device that is logged into a user account that was selected as part of the test group of users selected at 202. As another example, process 200 can receive a request for a video item from a user device with an IP address that was selected as part of the test group of users selected at 202.

At 206, process 200 can cause a user device to present a query related to the subjective intended activity of the user of the user device that requested the video item at 204.

In some embodiments, process 200 can cause a query to be presented to a user using any suitable technique or combination of techniques. For example, process 200 can transmit, to the user device that requested the video item, instructions that can cause the user device to present one or more queries to the user related to, for example, the user's intended activity, and prompt the user to enter a user input. As a more particular example, in a situation where process 200 received the request for the video item from a user device via a web browser, process 200 can transmit HTML instructions that can cause the web browser to present the user with one or more questions regarding the user's intended activity. In some embodiments, process 200 can transmit instructions that can cause one or more questions to be presented to the user before, during, and/or after the presentation of the requested video, or at any other suitable time.

In some embodiments, the query can include a user interface that allows a user to respond to the query via any suitable user input. For example, the query can include a user interface that includes a text window where a user can input a text response (e.g., via a keyboard, touch screen, voice input, or any other suitable text input device). As another example, the query can include a user interface that includes selectable user interface elements that each correspond to a different potential answer to the query.

In some embodiments process 200 can cause a query to be presented to a user by generating and transmitting an e-mail or other message that provides a user with the opportunity to answer questions concerning the user's intended activity with respect to a requested video item. For example, in a situation where a user device that is logged into a user account requests a video item, and the user account is associated with an e-mail address, process 200 can generate and transmit an e-mail to the associated e-mail address that includes the questions concerning the user's intended activity. In such an example, the e-mail can include any suitable prompt for the user to answer the questions, such as a prompt that instructs the user to respond via e-mail, a prompt that provides the user a hyperlink that directs to a web site where the user can answer the questions, any other suitable prompt, or any suitable combination thereof.

In some embodiments, the query can be related to any suitable information related to the user's intended activity. For example, the query can be related to the environment in which the user plans to view the video such as a work environment, a social environment, a relaxation environment, or any other suitable environment. As another example, the query can be related to the user's purpose for viewing the video, such as an instructional purpose, an entertainment purpose, a humorous purpose, an educational purpose, any other suitable purpose, or any suitable combination thereof. As yet another example, the query can be related to a social aspect of the user's intended activity, such as whether the user intended to watch the video with other persons, whether the user was referred to the video by another person, whether the user intended to share the video with other persons, any other social aspect of the user's intended activity, or any suitable combination thereof. As still another example, the query can be related to the user's attitude toward and/or preferences for a user interface, such as being related to whether the user was satisfied with the user interface, whether the user would prefer other user interface features, whether the user would prefer to use the user interface in a different setting, and/or any other suitable relation to the user's attitude toward and/or preferences for a user interface.

At 208, process 200 can receive the intended activity information based on the query.

In some embodiments, process 200 can receive the intended activity information using any suitable technique or combination of techniques. For example, in a situation where process 200 caused the query to be presented to a user using a user interface presented by the application used to request the media content item, process 200 can receive the intended activity information from the user device. As another example, in a situation where process 200 caused the query to be presented to a user via e-mail, process 200 can receive the intended activity information via e-mail. As yet another example, in a situation where process 200 caused the query to be presented to a user via a hyperlink, included in an email, that directs to a web site where the user can enter responses to questions (e.g., as described above in connection with 206), process 200 can receive the intended activity information via the web site.

At 210, process 200 can receive contextual information concerning the request for the video item using any suitable technique or combination of techniques. For example, process 200 can receive contextual information by requesting the contextual information from the user device that requested the video item. As another example, process 200 can request the information from a database that stores the information (e.g., a contextual information database as described below in connection with FIG. 9).

In some embodiments, the contextual information can include any suitable objective information concerning the request for the video item. For example, the contextual information can include the objective information described above in connection with 106 of FIG. 1.

At 212, process 200 can associate the subjective intended activity information received at 208 with the contextual information received at 210.

In some embodiments, process 200 can associate the subjective intended activity information and the contextual information using any suitable technique or combination of techniques. For example, process 200 can statistically analyze the subjective intended activity information and the contextual information to determine correlations between the subjective intended activity information and the contextual information using any suitable statistical analysis technique (e.g., a statistical analysis technique as described above in connection with 104 of FIG. 1). In such an example, process 200 can associate certain parameters of contextual information with certain types of subjective activity information in response to determining a relatively high correlation. As a more particular example, process 200 can determine that there is a relatively high correlation between a certain combination of contextual information parameters and intended activity information indicating that the user intends to view the requested video for entertainment.

In some embodiments, process 200 can refine the subjective intended activity information, and associate the refined information with the contextual information using any suitable technique or combination of techniques. For example, process 200 can refine the data by categorizing the data, encoding or re-coding the data, removing errors, refining the data using any other suitable technique, or any suitable combination thereof.

In some embodiments, associating the subjective intended activity information with the contextual information can be performed manually and/or refined manually. For example, associating the subjective intended activity information with the contextual information can be performed and/or refined based on input from an administrative user and/or a developer of the mechanisms described herein.

Although process 200 has been described herein as generally being directed toward video items, additionally or alternatively, in some embodiments, process 200 can be adapted to receiving information related to a user's intended use of any suitable type of media content item.

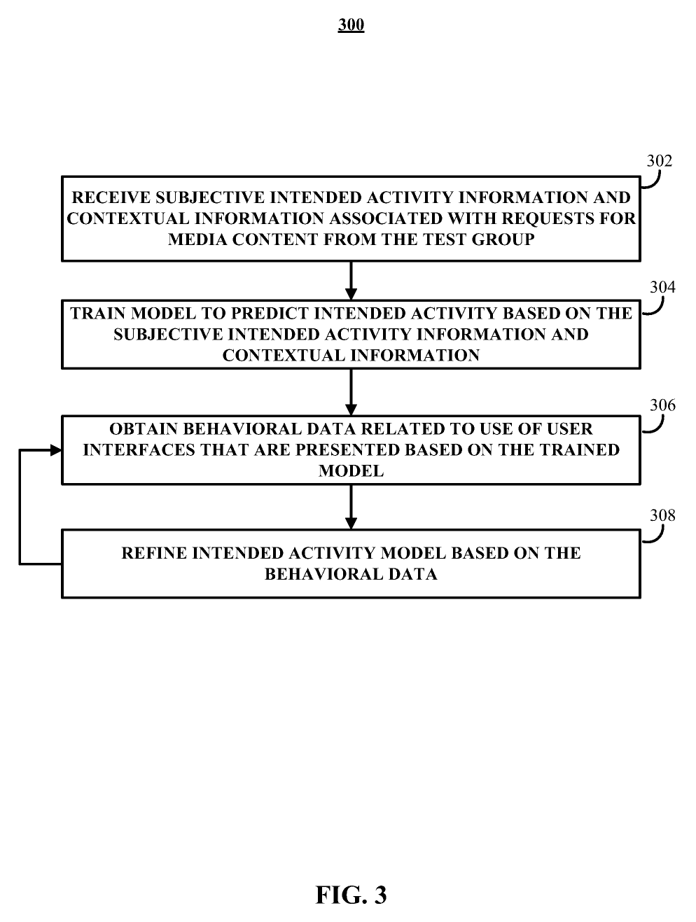

FIG. 3 shows an example 300 of a process for training a model to predict an intended user activity in accordance with some embodiments of the disclosed subject matter.

At 302, process 300 can receive subjective intended activity information and contextual information associated with requests for media content from the test group (e.g., the test group selected as described above in connection with 202 of FIG. 2).

In some embodiments, process 300 can receive any suitable subjective intended activity information. For example, process 300 can receive subjective intended activity information as described above in connection with 206 of FIG. 2.

In some embodiments, process 300 can receive any suitable contextual information. For example, process 300 can receive contextual information as described above in connection with 106 of FIG. 1.

At 304, process 300 can train a model to predict a user's intended activity based on the subjective intended activity information and contextual information received at 302.

In some embodiments, process 300 can train the model using any suitable technique or combination of techniques. For example, process 300 can use a technique as described above in connection with 104 of FIG. 1.

In some embodiments, in addition to the contextual information received at 302, process 300 can train the model based on contextual information that is not associated with the requests for media content from the test group. For example, process 300 can merge contextual information associated with requests for other media content (e.g., pre-existing contextual information) with the contextual information received at 302, and train the model based on the merged contextual information.

In some embodiments, process 300 can train multiple models that are each directed to different situations and/or different user information. For example, process 300 can train a model to predict a user's intended activity for users associated with a certain geographical region, users that are associated with known user accounts, users that frequently share content, any other suitable user information, or any suitable combination thereof. As another example, process 300 can train a model to predict a user's intended activity with respect to a certain type of requested media content. As a more particular example, with respect to video items, process 300 can train separate models to predict a user's intended activity with respect to requests for music videos, television shows, streaming videos, or any other suitable type of video item.

At 306, process 300 can obtain behavioral data related to use of user interfaces that are presented based on the trained model.

In some embodiments, process 300 can obtain any suitable behavioral data. For example, process 300 can obtain behavioral data related to search queries, click rates, rates at which users cast media content from a first user device to a second device, rates at which users shared media content items, times of received requests for media content items, times that user accounts logged in, comments that users posted, any other suitable behavioral data or any suitable combination thereof.

In some embodiments, process 300 can obtain behavioral data related to the presentation of user interfaces that correspond to a predicted intended activity. For example, process 300 can obtain behavioral data related to users requesting a different user interface after being provided a user interface that corresponds to a predicted intended activity. As a more particular example, in a situation where a user was presented with a user interface corresponding to presenting a video for instructional use (e.g., a user interface as described below in connection with FIG. 6A), process 300 can obtain data indicating that the user requested a different user interface for presenting the video.

As another example, process 300 can obtain behavioral data related to users manipulating certain features of a user interface, such as activation of a full screen feature, increasing or decreasing volume, expanding or collapsing user comments, and/or any other manipulation of user interface features.

In some embodiments, process 300 can obtain the behavioral data using any suitable technique or combination of techniques. For example, process 300 can query a database that stores the behavioral data. As another example, process 300 can obtain the behavioral data by storing data related to requests for media content items in response to receiving the requests. As yet another example, process 300 can query a user device for behavioral data stored by an application being used to request and/or present media content items. As a more particular example, process 300 can query a user device for data indicating when a user activated certain features of an application that includes a user interface for presenting a media content item and stores such data.

In some embodiments, in situations in which the mechanisms described herein collect personal information about users, or can make use of personal information, the users can be provided with an opportunity to control whether programs or features collect user information (e.g., behavioral data and/or contextual information, as described above), or to control whether and/or how such information can be used. In addition, certain data can be treated in one or more ways before it is stored or used, so that personal information is removed. For example, a user's identity can be treated so that no personal information can be determined for the user, or a user's geographic location can be generalized where location information is obtained (such as to a city, ZIP code, or state level), so that a particular location of a user cannot be determined. Thus, the user can have control over how information is collected about the user and used by the mechanisms described herein.

In some embodiments, process 300 can obtain behavioral data by causing one or more users of the media platform to be presented with queries related to their behavior with respect to the media platform. For example, process 300 can cause one or more users of the media platform to be presented with queries as described above in connection with 206 of FIG. 2. In some embodiments, the queries can be related to any suitable information concerning the user's behavior. For example, the query can be related to the reason that a user activated a user interface feature, requested a different user interface, requested a different media content item, any other suitable user behavior with respect to the media platform, or any suitable combination thereof.

At 308, process 300 can refine the intended activity model based on the obtained behavioral data.

In some embodiments, process 300 can refine the intended activity model based on the obtained behavioral data using any suitable technique or combination of techniques. For example, process 300 can utilize a machine learning algorithm to refine the parameters, coefficients, and/or variables in the model based on the obtained behavioral data. As a more particular example, in a situation where the model predicted that users intend to watch requested videos for entertainment, based on a set of contextual information that corresponds to a set of parameters and/or variables of the model, and the users were presented with user interfaces corresponding to entertainment, but behavioral data indicates that such users were dissatisfied with the user interface corresponding to entertainment, process 300 can refine the parameters, coefficients, and/or variables of the model such that the model can less frequently predict an intended activity of entertainment based on a similar set of contextual information.

In some embodiments, process 300 can refine the intended activity model by testing the model on the obtained behavioral data. For example, if the intended activity model predicts, for a particular set of requests for video items that are recorded in the obtained behavioral data, that the users associated with the requests intended to watch the video items as an instructional activity, but the behavioral data indicates that the video items were most often watched for entertainment (e.g., by indicating that users rarely paused the videos, frequently watched the videos in a full screen mode, any other suitable indication that video items were watched for entertainment, or any suitable combination thereof), process 300 can refine the intended activity model such that it can less frequently predict an instructional activity for the particular set of requests for video items and/or similar requests.

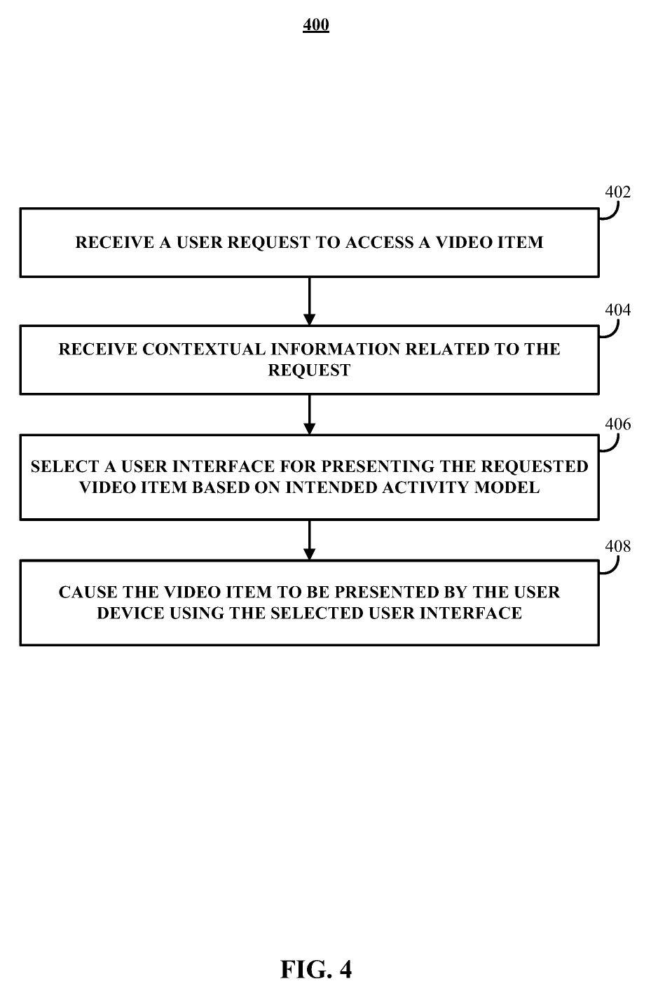

FIG. 4 shows an example 400 of a process for causing a user interface customized for a predicted user activity to be presented in accordance with some embodiments of the disclosed subject matter.

At 402, process 400 can receive a user request to access a video item.

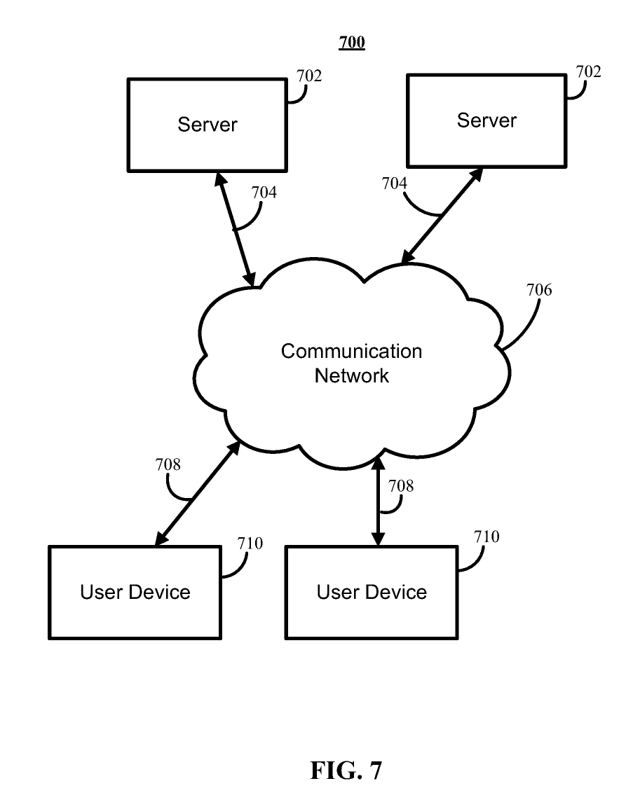

In some embodiments, the user request to access the video item can originate from any suitable source. For example, the request can originate from a user device 710, as described below in connection with FIG. 7, or any other device suitable for playing video content.

In some embodiments, the user request can be associated with and/or include any suitable information. For example, the user request can be associated with and/or include information as described above in connection with 202 of FIG. 2. As another example, the user request can be associated with and/or include contextual information at described below in connection with 404. As yet another example, the user request can be associated with and/or include information about the user device. As a more particular example, the request can be associated with and/or include information indicating that the request is originating from a user device that is logged into a known user account, information indicating a geographic region of the user device, information indicating the type of user device (e.g., mobile device, desktop computer, or any other suitable device type), any other suitable information related to the user device, or any suitable combination thereof.

At 404, process 400 can receive contextual information related to the request using any suitable technique or combination of techniques. For example, process 400 can receive the contextual information as part of the request (e.g., as described above in connection with 402). As another example, process 400 can send a request for the contextual information to the device that sent the request for the video item (e.g., a user device 710, as described below in connection with FIG. 7). As yet another example, process 400 can query a database for the contextual information (e.g., a database as described above in connection with FIG. 9).

In some embodiments, process 400 can receive any suitable contextual information. For example, process 400 can receive contextual information as described below in connection with 106 of FIG. 1 and/or 210 of FIG. 2.

At 406, process 400 can select a user interface for presenting the requested video item based on an intended activity model (e.g., the intended activity model as described above in connection with FIG. 1 and FIG. 3).

In some embodiments, process 400 can select a user interface that corresponds to, or includes features that correspond to, any suitable one or more intended activities predicted by the intended activity model (e.g., any suitable intended activity as described below in connection with 108 of FIG. 1). For example, in a situation where the intended activity model predicts that a user intends to watch the video as an instructional activity, process 400 can select a user interface that corresponds to an instructional activity (e.g., a user interface as described below in connection with FIG. 6A). As another example, in a situation where the intended activity model predicts that a user intends to watch the video as a shopping activity, process 400 can select a user interface that includes features corresponding to shopping, such as advertisements, the prices of products, product reviews, user comments, any other suitable user interface feature that corresponds to shopping, or any suitable combination thereof. As yet another example, in a situation where the intended activity model predicts that the user intends to watch the video as a part of casually browsing videos, process 400 can select a user interface that includes features corresponding to casual browsing, such as a listing of suggested videos, user comments, user ratings, a listing of top-rated videos, media content related to the requested video, any other suitable user interface feature corresponding to casual browsing, or any suitable combination thereof.

In some embodiments, process 400 can select a user interface with two or more features that each correspond to a different intended activity predicted by the intended activity model. For example, in a situation where the intended activity model predicts both an entertainment activity and an educational activity process 400 can select a user interface that includes a first feature that corresponds to an entertainment activity and a second feature that corresponds to an educational activity.

In some embodiments, process 400 can select a user interface based on any suitable indicator of a predicted activity that is produced by the intended activity model. For example, process 400 can select a user interface based on any suitable indicator as described above in connection with 106 of FIG. 1. Relatedly, in some embodiments, process 400 can select a user interface based on any suitable criteria related to the indicator produced by the intended activity model. For example, in a situation where the intended activity model produces a first probability that indicates a first intended activity, and a second probability that indicates a second intended activity, process 400 can select a user interface that corresponds to the predicted activity with the higher probability.

In some embodiments, process 400 can select any suitable user interface. For example, process 400 can select any suitable interface described above in connection with 110 of FIG. 1.

In some embodiments, in lieu of selecting the user interface based on the intended activity model, the user interface can be selected by the intended activity model directly. For example, the intended activity model can include pre-determined associations between predicted intended activities and customized user interfaces. As another example, in lieu of outputting a predicted intended activity, the intended activity model can output a suggested customized user interface.

In some embodiments, process 400 can select a user interface and/or a user interface feature that is predetermined to correspond to a predicted intended activity. For example, process 400 can receive a manual association (e.g., an association received via a user input from an administrator and/or via a developer of the mechanisms described herein) between a particular intended activity and a user interface that is customized for the particular intended activity, and select the customized user interface in situations where the model predicts the particular intended activity. As another example, process 400 can receive a manual association between a particular intended activity and a particular user interface feature, and select the particular user interface feature in situations where the model predicts the particular intended activity.

At 408, process 400 can cause the video item to be presented by the user device using the selected user interface using any suitable technique or combination of techniques. For example, process 400 can cause the user interface to be presented as described above in connection with 110 of FIG. 1.

Although process 400 has been described herein as generally being directed toward video items, additionally or alternatively, in some embodiments, process 400 can be adapted to selecting a user interface corresponding to a user's intended use of any suitable type of media content item.

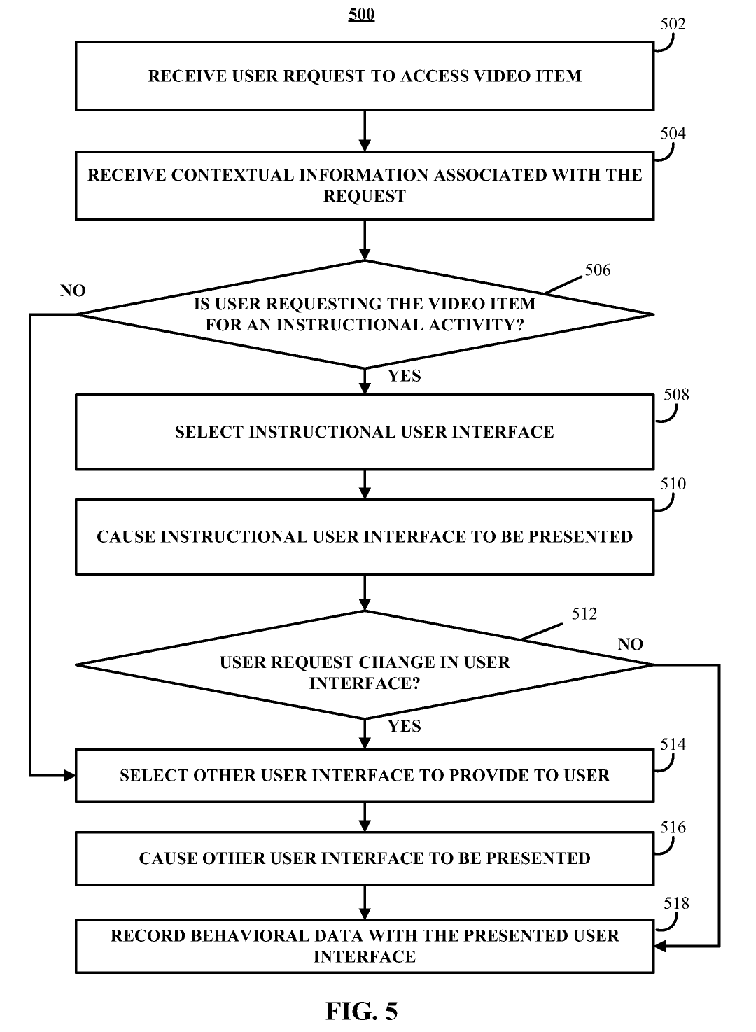

FIG. 5 shows an example 500 of a process for causing a user interface for a predicted instructional activity to be presented in accordance with some embodiments of the disclosed subject matter.

At 502, process 500 can receive a request for a video item using any suitable technique or combination of techniques. For example, process 500 can receive a request as described above in connection with 402 of FIG. 4.

At 504, process 500 can receive contextual information associated with the request using any suitable technique or combination of techniques. For example, process 500 can receive contextual information as described above in connection with 106 of FIG. 1, 210 of FIG. 2, and/or 404 of FIG. 4.

At 506, process 500 can predict whether the user associated with the request for the video item requested the video item for an instructional activity.

In some embodiments, process 500 can predict whether the user requested the video item for an instructional activity based on an intended activity model, such as the intended activity model described above in connection with FIG. 1 and FIG. 3.

In some embodiments, process 500 can predict whether the user requested the video item for an instructional activity based on any suitable information. For example, process 500 can predict whether the user requested the video item for an instructional activity based on metadata associated with the requested video item (e.g., as described above in connection with 406 of FIG. 4) and/or contextual information associated with an instructional activity. As a more particular example, process 500 can predict that a requested video was requested for an instructional activity based at least in part on metadata associated with the video that includes a description of the video with words indicating that the video is instructional (e.g., “how to” or “instructions”).

In some embodiments, after predicting that the user requested the video item for an instructional activity, process 500 can continue at 508 by selecting an instructional user interface.

In some embodiments, process 500 can select any user interface suitable for an instructional activity. For example, process 500 can select a user interface as shown in FIG. 6A and described below in connection with FIG. 6A. As another example, process 500 can select a user interface that includes features directed to an instructional activity. As a more particular example, the user interface can include a feature that presents user comments based on a particular time during the playback of the video, a feature that allows a user to take notes during playback of the video, any other suitable feature directed to an instructional activity, or any suitable combination thereof.

At 510, process 500 can cause the instructional user interface selected at 508 to be presented to the user using any suitable technique or combination of techniques. For example, process 500 can cause the user interface to be presented using a technique as described below in connection with 408 of FIG. 4.

At 512, process 500 can determine whether a user requested a change of user interface.

In some embodiments, process 500 can determine whether a user requested a change of user interface based on a request received from a user device. For example, in a situation where process 500 caused an instructional user interface to be presented by the user device associated with the request for a video item, if process 500 receives a request from the user device for a different user interface (e.g., a request associated with a user selection of a user interface element configured to change the user interface), process 500 can determine that the user requested a change of user interface based on the received request. As a more particular example, in a situation where the instructional user interface includes a selectable element configured to cast the video item to a second device, process 500 can receive a corresponding request to cast the video item (either from the second device or from the user device), and determine that the user requested a change of user interface. As another more particular example, in a situation where the instructional user interface includes a selectable element for changing user interface preferences, process 500 can receive a request corresponding to a user selection of the selectable element for changing user interface preferences, and determine that the user requested a change of user interface.

In some embodiments, after determining that the user requested a change in user interface at 512, or after predicting that the user is not requesting the video item for an instructional activity at 506, process 500 can continue at 514 by selecting another user interface to provide to the user using any suitable technique or combination of techniques. For example, process 500 can select a user interface based on user input indicating a preference for another user interface. In some embodiments, in a situation where the intended activity model provided an indication, at 506, that one or more intended activities other than an instructional activity was possible (e.g., by producing a first score associated with an instructional activity and a second score associated with a second activity, as described above in connection with 406 of FIG. 4), process 500 can select a user interface that corresponds with the one or more intended activities other than an instructional activity.

In some embodiments, in response to receiving a selection that another user interface should be provided to the user at 514, process 500 can continue at 516 by causing the other user interface, selected at 514, to be presented. In some embodiments, process 500 can cause the other user interface to be presented using any suitable technique or combination of techniques. For example, process 500 can cause the other user interface to be presented using a technique as described above in connection with 510.

It should be noted that, similar to 512, the user can be provided with another opportunity to request to change the user interface. In response to determining that the user requested a change in the user interface, process 500 can continue by selecting yet another user interface to provide to the user using any suitable technique or combination of techniques. For example, process 500 can select a user interface based on user input indicating a preference for another user interface.

At 518, process 500 can record behavioral data associated with the presented user interface.

In some embodiments, process 500 can record any suitable behavioral data. For example, process 500 can record behavioral data as described above in connection with 306 of FIG. 3. As another example, process 500 can record behavioral data associated with a request for a change of user interface, as described above in connection with 514. As yet another example, process 500 can record subjective intended activity data as described above in connection with 206 of FIG. 2 (e.g., by causing the user to be presented with a query related to the user's subjective intended activity as also described above in connection with 206 of FIG. 2).

Although process 500 has been described herein as generally being directed toward video items, additionally or alternatively, in some embodiments, process 500 can be adapted to selecting a user interface corresponding to an instructional activity for any suitable type of media content item.

It should be noted that, in some embodiments, process 100, process 200, process 300, process 400, and/or process 500 can cause some or all of the above-described blocks to be performed by a third party device or third party process.

FIG. 6A shows an example 600 of a user interface that is customized for an instructional user activity in accordance with some embodiments of the disclosed subject matter. As shown in FIG. 6A, in some embodiments, user interface 600 can include a portion 602 for presenting the requested video item, as well as elements that are customized for an instructional user activity, such as a portion 604 for presenting a video progress bar annotated with step markers 612, 614, and 616, and a steps portion 606 for presenting a list of written steps including a highlighted written step 608 and a user comment 610.

In some embodiments, step markers 612, 614, and 616 can correspond to any suitable point in time and/or span of time in the video item. For example, step markers 612, 614, and 616 can each correspond to a point in time in the video item where a separate step is started, being discussed, and/or being demonstrated. In some embodiments, step markers 612, 614, and 616 can also correspond to a written step of the list of written steps 606. As a more particular example, as illustrated in FIG. 6A, step marker 612 (illustrated with “#1”) can correspond to the highlighted written step 608 (illustrated with “Step #1”). In some embodiments, step markers 612, 614, and 616 can be selectable user interface elements such that, upon being selected by a user, can cause the user interface to take any suitable corresponding action. For example, step marker 612 can be configured to, upon being selected by a user, cause written step 608 to expand or collapse, cause the video to jump to a point in time corresponding to the location of the marker, take any other suitable corresponding action, or any suitable combination thereof.

In some embodiments, highlighted written step 608 can correspond to a point in time or span in time of the video related to the step. For example, highlighted written step 608 can remain highlighted during a span in time of the video where “Step #1” is being discussed and/or demonstrated. Additionally or alternatively, highlighted written step can become un-highlighted when a different step is being discussed and/or demonstrated.

In some embodiments, user comment 610 can correspond to a step among the list of steps in steps portion 606. For example, as illustrated in FIG. 6A, user comment 610 can correspond to highlighted step 608.

FIG. 6B shows an example 650 of a user interface that is customized for an entertainment activity in accordance with some embodiments of the disclosed subject matter. As shown in FIG. 6B, in some embodiments, user interface 650 can include a portion 652 for presenting the requested video item, a portion 654 for presenting video controls that includes a casting element 656, and a portion 662 for presenting user comments, including user comments 658 and 660. In some embodiments, casting element 656 can be any user interface element suitable for causing the requested video item to be presented by another device. In some embodiments, portion 654 can include any user interface elements suitable for controlling the presentation of the requested video item. For example, portion 654 can include a user interface element for controlling volume, screen size, video resolution, any other suitable user interface element for controlling the presentation of the requested video item, or any suitable combination thereof.

FIG. 7 shows a schematic diagram of a system 700 suitable for implementation of the mechanisms described herein for presenting a user interface customized for a predicted user activity in accordance with some embodiments of the disclosed subject matter. As illustrated, system 700 can include one or more servers 702, as well as a communication network 706, and/or one or more user devices 710.

In some embodiments, server 702 can be any server suitable for implementing some or all of the mechanisms described herein for causing a user interface customized for a predicted user activity to be presented. For example, server 702 can be a server that executes an intended activity model (e.g., as described above with respect to FIG. 1 and FIG. 3) and/or causes one or more user devices 710 to present a corresponding user interface by sending instructions to the one or more user devices 710 via communication network 706. In some embodiments, one or more servers 702 can provide media content to the one or more user devices 710 via communication network 706. In some embodiments, one or more servers 702 can host a database of contextual information (e.g., as described above in connection with 106 of FIG. 1 and/or below in connection with FIG. 9), host a database of behavioral data (e.g., as described above in connection with 306), and/or host a database of user account information (e.g., as described above in connection with 106 of FIG. 1).

Communication network 706 can be any suitable combination of one or more wired and/or wireless networks in some embodiments. For example, communication network 706 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 710 can be connected by one or more communications links 708 to communication network 706 which can be linked via one or more communications links 704 to server 702. Communications links 704 and/or 708 can be any communications links suitable for communicating data among user devices 710 and servers 702, such as network links, dial-up links, wireless links, hard-wired links, any other suitable communications links, or any suitable combination of such links.

User devices 710 can include any one or more user devices suitable for requesting media content, searching for media content, presenting media content, presenting advertisements, presenting user interfaces, receiving input for presenting media content and/or any other suitable functions. For example, in some embodiments, user devices 710 can be implemented as a mobile device, such as a mobile phone, a tablet computer, a laptop computer, a vehicle (e.g., a car, a boat, an airplane, or any other suitable vehicle) entertainment system, a portable media player, and/or any other suitable mobile device. As another example, in some embodiments, user devices 710 can be implemented as a non-mobile device such as a desktop computer, a set-top box, a television, a streaming media player, a game console, and/or any other suitable non-mobile device.

Although two servers 702 are shown in FIG. 7 to avoid over-complicating the figure, the mechanisms described herein for presenting a user interface customized for a predicted user activity can be performed using any suitable number of devices in some embodiments. For example, in some embodiments, the mechanisms can be performed by a single server 702 or multiple servers 702.

Although two user devices 710 are shown in FIG. 7 to avoid over-complicating the figure, any suitable number of user devices, and/or any suitable types of user devices, can be used in some embodiments.

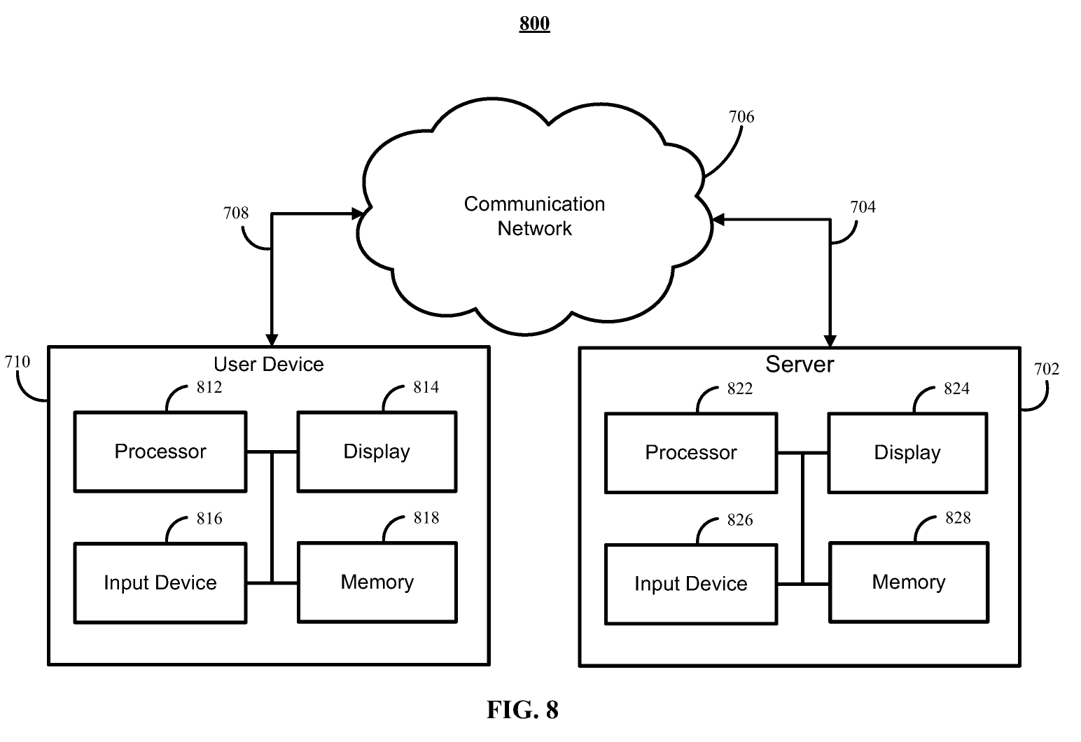

Servers 702 and user devices 710 can be implemented using any suitable hardware in some embodiments. For example, servers 702 and user devices 710 can be implemented using hardware as described below in connection with FIG. 8. As another example, in some embodiments, devices 702 and 710 can be implemented using any suitable general purpose computer or special purpose computer. Any such general purpose computer or special purpose computer can include any suitable hardware.

FIG. 8 shows an example of hardware 800 that can be used in a server and/or a user device of FIG. 7 in accordance with some embodiments of the disclosed subject matter.

User device 710 can include a hardware processor 812, memory and/or storage 818, an input device 816, and a display 814. In some embodiments, hardware processor 812 can execute one or more portions of the mechanisms described herein, such as mechanisms for: initiating requests for content; initiating requests for a user interface; presenting a query to a user; and/or presenting a user interface (e.g., via display 814). In some embodiments, hardware processor 812 can perform any suitable functions in accordance with instructions received as a result of, for example, process 100 as described below in connection with FIG. 1, process 200 as described above in connection with FIG. 2, process 300 as described above in connection with FIG. 3, process 400 as described above in connection with FIG. 4, and/or process 500 as described above in connection with FIG. 5, and/or to send and receive data through communications link 708. In some embodiments, hardware processor 812 can send and receive data through communications link 708 or any other communication links using, for example, a transmitter, a receiver, a transmitter/receiver, a transceiver, or any other suitable communication device. In some embodiments, memory and/or storage 818 can include a storage device for storing data received through communications link 708 or through other links. The storage device can further include a program for controlling hardware processor 822. In some embodiments, memory and/or storage 828 can include information stored as a result of user activity (e.g., sharing content, requests for content, etc.). Display 814 can include a touchscreen, a flat panel display, a cathode ray tube display, a projector, a speaker or speakers, and/or any other suitable display and/or presentation devices. Input device 816 can be a computer keyboard, a computer mouse, a touchpad, a voice recognition circuit, a touchscreen, and/or any other suitable input device.

Server 820 can include a hardware processor 822, a display 824, an input device 826, and memory and/or storage 828, which can be interconnected. In some embodiments, memory and/or storage 828 can include a storage device for storing data received through communications link 704 or through other links. The storage device can further include a server program for controlling hardware processor 822. In some embodiments, memory and/or storage 828 can include information stored as a result of user activity (e.g., sharing content, requests for content, etc.), and hardware processor 822 can receive requests for media content and/or requests for a user interface. In some embodiments, the server program can cause hardware processor 822 to, for example, execute at least a portion of process 100 described above in connection with FIG. 1, process 200 described above in connection with FIG. 2, process 300 described above in connection with FIG. 3, process 400 described above in connection with FIG. 4, and/or process 500 described above in connection with FIG. 5.

Hardware processor 822 can use the server program to communicate with user devices 710 as well as provide access to and/or copies of the mechanisms described herein. It should also be noted that data received through communications links 704 and/or 708 or any other communications links can be received from any suitable source. In some embodiments, hardware processor 822 can send and receive data through communications link 704 or any other communication links using, for example, a transmitter, a receiver, a transmitter/receiver, a transceiver, or any other suitable communication device. In some embodiments, hardware processor 822 can receive commands and/or values transmitted by one or more user devices 710, such as a user that makes changes to adjust settings associated with the mechanisms described herein for presenting customized user interfaces. Display 824 can include a touchscreen, a flat panel display, a cathode ray tube display, a projector, a speaker or speakers, and/or any other suitable display and/or presentation devices. Input device 826 can be a computer keyboard, a computer mouse, a touchpad, a voice recognition circuit, a touchscreen, and/or any other suitable input device.

Any other suitable components can be included in hardware 800 in accordance with some embodiments.

FIG. 9 shows a more detailed example of a system 900 suitable for implementation of the mechanisms described herein for presenting a user interface customized for a predicted user activity in accordance with some embodiments of the disclosed subject matter.

In some embodiments, a population 902 can include a test group 904. In some embodiments, population 902 can include any suitable persons. For example, population 902 can include users of a social media platform (e.g., as described above in connection with 102 of FIG. 1), and/or persons that do not currently use a social media platform. In some embodiments, test group 904 can be a test group as described above in connection with FIG. 1 and FIG. 2.

In some embodiments, subjective intended activity database 906 can receive subjective intended activity information from test group 904. In some embodiments, subjective intended activity database 906 can store any suitable subjective intended activity information, such as subjective intended activity information as described above in connection with FIG. 1 and FIG. 2. In some embodiments, subjective intended activity database 906 can be hosted by a server 702, as described above in connection with FIG. 7 and FIG. 8. In some embodiments, the subjective intended activity information stored in subjective intended activity database 906 can be manipulated and/or refined (e.g., as described above in connection with 212 of FIG. 2) via system administrator 914.

In some embodiments, contextual information database 910 can receive contextual information from population 902 and/or test group 904. In some embodiments, contextual information database 910 can store any suitable contextual information, such as contextual information as described above in connection with FIG. 1 and FIG. 2. In some embodiments, contextual information database 910 can be hosted by a server 702, as described above in connection with FIG. 7 and FIG. 8. In some embodiments, the contextual information stored in contextual information database 910 can be manipulated and/or refined via system administrator 914.

In some embodiments, user interface associations 908 can be based on subjective intended activity information received from subjective intended activity database 906. In some embodiments, user interface associations 908 can include any suitable associations between user interfaces and/or user interface features and intended activities. For example, the user interface association can include pre-determined user interface associations and/or pre-determined user interface feature associations as described above in connection with 406 of FIG. 4. In some embodiments, user interface associations 908 can be determined and/or input by system administrator 914.

In some embodiments, intended activity model 912 can be any suitable intended activity model, such as an intended activity model as described above in connection with FIG. 1 and FIG. 3. In some embodiments, intended activity model 912 can be based on information received from subjective intended activity database 906, and contextual information database 910. For example, as described below in connection with FIG. 1, FIG. 2, FIG. 3, and FIG. 4, intended activity model 912 can be trained based on subjective intended activity received from subjective intended activity database 906 and contextual information received from contextual information database 910. In some embodiments, intended activity model 912 can select a user interface based on user interface associations received from user interface associations 908. In some embodiments, as illustrated in FIG. 9, intended activity model 912 can receive a request from a user device associated with a person included in population 902 (e.g., a request for media content and/or a request for a user interface), and based on contextual information (e.g., received from contextual information database 910 and/or from the user device), as illustrated in FIG. 9, send a user interface selection (“U.I. selection”) to the user device associated with a person included in population 902. In some embodiments, system administrator 914 can refine the parameters, coefficients, and/or variables of intended activity model 912 (e.g., as described above in connection with 308 of FIG. 3).

In some embodiments, at least some of the above described blocks of the processes of FIG. 1, FIG. 2, FIG. 3, FIG. 4 and/or FIG. 5 can be executed or performed in any order or sequence not limited to the order and sequence shown in and described in connection with the figures. Also, some of the above blocks of FIG. 1, FIG. 2, FIG. 3, FIG. 4, FIG. 5, and/or FIG. 9 can be executed or performed substantially simultaneously where appropriate or in parallel to reduce latency and processing times. Additionally or alternatively, in some embodiments, some of the above described blocks of the processes of FIG. 1, FIG. 2, FIG. 3, FIG. 4 and/or FIG. 5 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as magnetic media (e.g., hard disks, floppy disks, and/or any other suitable magnetic media), optical media (e.g., compact discs, digital video discs, Blu-ray discs, and/or any other suitable optical media), semiconductor media (e.g., flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Accordingly, methods, systems, and media for presenting a user interface customized for a predicted user activity are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for presenting a customized user interface, comprising:
selecting at least a plurality of users of a content delivery service from users of the content delivery service;
for a plurality of user devices associated with the plurality of users:
receiving requests for media content items;
receiving objective data related to the context in which the requests for media content items were made;
causing each of the plurality of user devices to prompt the associated users to provide subjective data related to the user's intent when requesting the media content items; and
receiving subjective data generated based on user input responsive to the prompt;
receiving, from a first user device, input that maps each of a plurality of user intents to at least one of a plurality of different user interfaces for presenting media content items;
training a predictive model to identify a user's subjective intent in requesting a media content item based on objective data received from a user device associated with the user using at least a portion of the objective data received from the plurality of user devices and at least a portion of the subjective data received from the plurality of user devices, wherein the predictive model is trained to identify whether to present the user with a first user interface associated with a first user intent or a second user interface associated with a second user intent;
receiving, from a second user device, a request for a first media content item;
receiving, from the second user device, objective data related to the context in which the request for the first media content item was made;
providing at least a portion of the objective data received from the second user device to the predictive model;
receiving a first output from the predictive model indicating that the second user device is to present the first media content item using the first user interface;
in response to receiving the first output from the predictive model, causing the second user device to present the first media content item using the first user interface;
receiving, from a third user device, a request for the first media content item;
receiving, from the third user device, objective data related to the context in which the request for the first media content item was made;
providing at least a portion of the objective data received from the third user device to the predictive model;
receiving a second output from the predictive model indicating that the third user device is to present the first media content item using the second user interface; and
in response to receiving the second output from the predictive model, causing the third user device to present the first media content item using the second user interface.

2. The method of claim 1, wherein a first user intent of the plurality of user intents is an intent to consume the media content item for information included in the media content item.

3. The method of claim 2, wherein a second user intent of the plurality of user intents is an intent to consume the media content item for entertainment.

4. The method of claim 3, wherein causing each of the plurality of user devices to prompt the associated users comprises causing each of the plurality of user devices to query the user to determine whether the user intended to consume the requested media content primarily for entertainment or primarily for the information included in the media content.

5. The method of claim 1, wherein the objective data includes information indicating whether the request was initiated from search results provided through the content delivery service.

6. The method of claim 5, wherein the objective data includes a search query that was used in initiating the search.

7. A method for presenting a customized user interface, comprising:
identifying contextual information related to the context in which the requests for
media content items were made from a plurality of user devices associated with the plurality of users;
providing a prompt to each of the plurality of user devices to provide intent information related to the user's intent when requesting the media content items;
receiving the intent information in response to the prompt;
generating a trained predictive model that identifies a user's intent when requesting a media content item with the identified contextual information and the received intent information, wherein the trained predictive model determines which version of a user interface is to be presented based on a predicted user intent determined based on information related to the context in which a request for media content is being made;
receiving, from a second plurality of user devices, requests for media content items;
identifying, for each request for a media content item received from the second plurality of user devices, contextual information related to the context in which the request for the media content items was made;
receiving, for each request for a media content item received from the second plurality of user devices, an output from the predictive model indicating which version of the user interface to present based on at least a portion of the identified context information; and
causing each of the second plurality of user devices to present a version of the user interface for presenting media content based on the output from the predictive model, wherein two user devices of the second plurality of user devices are caused to present two different versions of the user interface to present the same media content item based on the output of the predictive model.

8. A system for presenting a custom user interface, the system comprising:
a memory that stores computer-executable instructions; and
a hardware processor that, when executing the computer-executable instructions stored in the memory, is configured to:
select at least a plurality of users of a content delivery service from users of the content delivery service;
for a plurality of user devices associated with the plurality of users:
receive requests for media content items;
receive objective data related to the context in which the requests for media content items were made;
cause each of the plurality of user devices to prompt the associated users to provide subjective data related to the user's intent when requesting the media content items; and
receive subjective data generated based on user input responsive to the prompt;
receive, from a first user device, input that maps each of a plurality of user intents to at least one of a plurality of different user interfaces for presenting media content items;
train a predictive model to identify a user's subjective intent in requesting a media content item based on objective data received from a user device associated with the user using at least a portion of the objective data received from the plurality of user devices and at least a portion of the subjective data received from the plurality of user devices, wherein the predictive model is trained to identify whether to present the user with a first user interface associated with a first user intent or a second user interface associated with a second user intent;
receive, from a second user device, a request for a first media content item;
receive, from the second user device, objective data related to the context in which the request for the first media content item was made;
provide at least a portion of the objective data received from the second user device to the predictive model;
receive a first output from the predictive model indicating that the second user device is to present the first media content item using the first user interface;
in response to receiving the first output from the predictive model, cause the second user device to present the first media content item using the first user interface;
receive, from a third user device, a request for the first media content item;
receive, from the third user device, objective data related to the context in which the request for the first media content item was made;
provide at least a portion of the objective data received from the third user device to the predictive model;
receive a second output from the predictive model indicating that the third user device is to present the first media content item using the second user interface; and
in response to receiving the second output from the predictive model,
causing the third user device to present the first media content item using the second user interface.

9. The system of claim 8, wherein a first user intent of the plurality of user intents is an intent to consume the media content item for information included in the media content item.

10. The system of claim 9, wherein a second user intent of the plurality of user intents is an intent to consume the media content item for entertainment.

11. The system of claim 10, wherein causing each of the plurality of user devices to prompt the associated users comprises causing each of the plurality of user devices to query the user to determine whether the user intended to consume the requested media content primarily for entertainment or primarily for the information included in the media content.

12. The system of claim 8, wherein the objective includes information indicating whether the request was initiated from search results provided through the content delivery service.

13. The system of claim 12, wherein the objective data includes a search query that was used in initiating the search.

14. A non-transitory computer-readable medium containing computer-executable instructions that, when executed by a processor, cause the processor to perform a method for presenting a customized user interface, the method comprising:
selecting at least a plurality of users of a content delivery service from users of the content delivery service;
for a plurality of user devices associated with the plurality of users:
receiving requests for media content items;
receiving objective data related to the context in which the requests for media content items were made;
causing each of the plurality of user devices to prompt the associated users to provide subjective data related to the user's intent when requesting the media content items; and
receiving subjective data generated based on user input responsive to the prompt;
receiving, from a first user device, input that maps each of a plurality of user intents to at least one of a plurality of different user interfaces for presenting media content items;
training a predictive model to identify a user's subjective intent in requesting a media content item based on objective data received from a user device associated with the user using at least a portion of the objective data received from the plurality of user devices and at least a portion of the subjective data received from the plurality of user devices, wherein the predictive model is trained to identify whether to present the user with a first user interface associated with a first user intent or a second user interface associated with a second user intent;
receiving, from a second user device, a request for a first media content item;
receiving, from the second user device, objective data related to the context in which the request for the first media content item was made;
providing at least a portion of the objective data received from the second user device to the predictive model;
receiving a first output from the predictive model indicating that the second user device is to present the first media content item using the first user interface;
in response to receiving the first output from the predictive model, causing the second user device to present the first media content item using the first user interface;
receiving, from a third user device, a request for the first media content item;
receiving, from the third user device, objective data related to the context in which the request for the first media content item was made;
providing at least a portion of the objective data received from the third user device to the predictive model;
receiving a second output from the predictive model indicating that the third user device is to present the first media content item using the second user interface; and
in response to receiving the second output from the predictive model, causing the third user device to present the first media content item using the second user interface.

15. The non-transitory computer-readable medium of claim 14, wherein a first user intent of the plurality of user intents is an intent to consume the media content item for information included in the media content item.

16. The non-transitory computer-readable medium of claim 15, wherein a second user intent of the plurality of user intents is an intent to consume the media content item for entertainment.

17. The non-transitory computer-readable medium of claim 16, wherein causing each of the plurality of user devices to prompt the associated users comprises causing each of the plurality of user devices to query the user to determine whether the user intended to consume the requested media content primarily for entertainment or primarily for the information included in the media content.

18. The non-transitory computer-readable medium of claim 14, wherein the objective data includes information indicating whether the request was initiated from search results provided through the content delivery service.

19. The non-transitory computer-readable medium of claim 18, wherein the objective data includes a search query that was used in initiating the search.
